(19) United States
(12) Patent Application Publication
(10) Pub. No.: US 2012/0224799 A1
(43) Pub. Date: Sep. 6, 2012

(54) BEARING ASSEMBLY FOR A WIND TURBINE

(75) Inventor: Juergen Wagner, Berlin (DE)

(73) Assignee: Suzlon Energy GmbH, Rostock (DE)

(21) Appl. No.: 13/500,229

(22) PCT Filed: Oct. 17, 2010
(86) PCT No.: PCT/EP2010/065578

§ 371 Date: May 17, 2012

(30) Foreign Application Priority Data
Oct. 16, 2009 (DE) 10 2009 049 769.2

(51) Int. Cl. F16C 17/04

(52) U.S. Cl. 384/308

(57) ABSTRACT

The present invention relates to a bearing device for a wind turbine, wherein the bearing arrangement has two bearing partners, which are pivoted arranged relative to each other over a common axis. A gliding pad acting in an axial direction is provided between the bearing partners. The object of the invention is to provide a bearing arrangement for a wind turbine, which among others avoids the disadvantages of the prior art. In particular, a maintenance-friendly and force flow-optimized arrangement of the gliding pads is to be enabled. The replaceability of the gliding pads is to be improved in a simple and cost-effective manner by disposing the individual gliding pads in pockets between the two bearing partners, wherein the pockets are provided in the material of the machine frame. Additionally, the option exists to use the bearing arrangement at the same time as an active brake.

The present invention relates to a bearing device for a wind turbine, wherein the bearing arrangement has two bearing partners, which are arranged rotatably relative to each other about a common axis. A gliding pad acting in an axial direction is provided between the bearing partners. For wind turbines, such bearing arrangements are arranged between the tower of the facility and the nacelle, and are used inter alia to absorb and transfer thrust, centrifugal and yawing forces from the machine frame of the nacelle to the tower. The wind tracking of the nacelle is here enabled by means of the bearing arrangement, the so-called azimuth bearing and the azimuth drive. Here, the nacelle is rotated in the horizontal plane about a substantially vertical rotation axis in such a manner that the wind perpendicularly flows against a rotation plane of the rotor and consequently the energy output is maximized.

### BACKGROUNDS

Such a bearing arrangement is known from EP 124702181. Here, a slide bearing is mentioned, wherein an embodiment presents the features specified in the preamble of the independent claim. An annular rib arranged on a bearing partner engages into an annular groove provided on another bearing partner, which is provided with circumferential surfaces having gliding pads. The gliding pads are divided into segments and connected fixedly, but detachably to the rib. This allows the inspection of the gliding pads and, if necessary, their replacement in operation. The outer ring is divided into segments which are fixed on the supporting framework by means of screws. This may be evaluated as disadvantageous, because the number of linings arranged in a circle is very high. This requires a high number of pieces, i.e. higher costs due to increased wear and thus an increased necessity for replacement of the linings. Furthermore, the replacement of the linings is made more difficult by their fixing by means of screws.

### SUMMARY OF INVENTION

It is an object of the invention to provide a bearing arrangement for a wind turbine, which inter alia avoids the disadvantages of the prior art. In particular, a maintenance-friendly and force flow-optimized arrangement of the gliding pads is to be enabled. The replaceability of the gliding pads is to be improved in a simple and cost-effective manner. It exists also the option that the bearing arrangement can simultaneously serve as an active brake.

The object is achieved according to the invention with the features of the independent claim 1 by the fact that the individual gliding pads are arranged in pockets between the two bearing partners, wherein the pockets are provided in the material of the machine frame.

The axial gliding pads are disc-shaped, so that they can be sawn from plate material, whereby expensive milling or turning operations are not required.

At least one stop is provided on the pocket in such a manner that the gliding pads is mountable, and thus a form fit connection for power transmission, which is effective in a circumferential direction, is provided between the slide lining and the bearing partner. This results in the advantage that less linings are provided, which are disposed in the pockets.

An advantageous characteristic of the invention is that the construction is designed so that the necessary machine processing can be effected one-sided on the bottom side of the machine frame. The chipping volume is small and no particular requirements on form and position tolerances as well as the surface quality are raised.

The pocket is provided as a recess directly in one of the bearing partners, recommendable directly on the machine frame. The pocket extends to a radial edge of the machine frame, thus the replaceability of the gliding pads becomes simplified and more economical.

The pocket is designed in such a manner that the gliding pad is mountable in a radial direction. By the fact that the gliding pads are divided into segments, they can be replaced individually. The pocket includes a first radially effective arrester, which limits the moving possibility of the slide lining in the assembled state. This prevents that the gliding pad may radially slide out of the pocket during the operation. A second radially effective arrester, which is formed as a stopper, fixes the radial position of the assembled slide lining.

The axial gliding pads are loaded by springs. Due to the flexibility of the disc spring construction, the system is relatively insensitive to unevenness of the bearing ring. Furthermore, the system offers the possibility to be able to set the inhibition in a wide range by changing the axial and radial pretension. The setting of the radial pretension is carried out via the vertical movement of the conical gliding pad. For this purpose, adjusting screws, through which the radial pad can be moved along the wedge, are provided not only in the machine frame but also in the locking plate.

Lifting means are provided for replacing the gliding pads. The lower gliding pads are released from the spring tension so that the gliding pads are located in the pockets in an unloaded state. The two bearing partners are lifted away from each other by hydraulic posts, which are temporarily installed and operated by means of a manually operating hydraulic pump, and the gliding pads can be replaced.

One bearing partner encompasses the other bearing partner in the axial direction, wherein a further gliding pad is provided between the bearing partners. In this case, a bearing partner, which is designed as a machine frame, is arranged rotatably relative to another bearing partner, which is designed as a bearing ring, over a common axis. An external tooth system is provided on the bearing ring. It should be noted that the bearing can be guided not only internally but also externally. Accordingly, the toothing provided on the bearing ring is provided internally or externally, however, internal toothings are usually associated with higher production costs.

The lubricant supply is ensured by a lubricating unit in the machine frame. After a certain period of use of the bearing arrangement, it can be relubricated from the outside in order to compensate for a possible loss of lubricant. A simple felt pad with a lubricant supply ensures the lubrication of the linings.

A further advantage of the invention is that at least one actively actuatable brake device is provided in a bearing partner. For this purpose, hydraulic cylinders can be installed into the corresponding bores of the locking plates instead of disc spring units.

### BRIEF DESCRIPTION OF THE DRAWINGS

Further details of the invention will become apparent from the drawings on the basis of the description.

In the drawings,

FIG. 1 shows an illustration of a wind turbine,

FIG. 2 shows a perspective view of an underside of a first embodiment of a bearing arrangement of a wind turbine according to FIG. 1,

FIG. 3 shows another view of the bearing arrangement according to FIG. 2,

FIG. 4 shows a top view of the bearing arrangement according to FIG. 2,

FIG. 5 shows a section through the bearing arrangement taken along line B-B according to FIG. 4,

FIG. 6 shows a section through the bearing arrangement taken along line C-C according to FIG. 4,

FIG. 7 shows a section through the bearing arrangement taken along line A-A according to FIG. 4.

### PREFERRED EMBODIMENTS

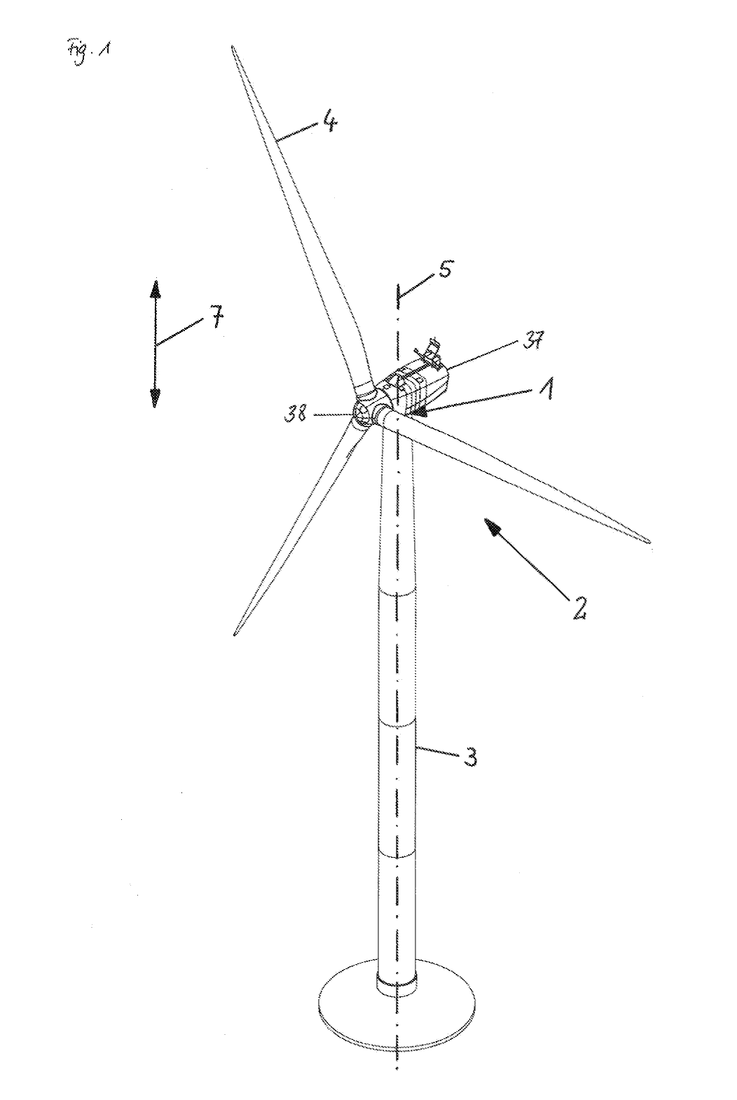

FIG. 1 shows a wind turbine 2 with a tower 3 and a rotatable machine housing 37, which is positioned on the tower 3. Based on the necessary wind tracking, the machine housing is supported on the tower 3, pivoted over a vertical axis 5 via a bearing arrangement 1, the so-called azimuth bearing. The wind direction tracking is performed by the azimuth bearing 1 and an azimuth drive. The drive train, comprising a rotor shaft and a gear box, and a generator, connected with the fast shaft of the gear box, are located in the machine housing 37. The drive train is supported on the machine frame 10 via a rotor bearing and via the gear box. A rotor flange, on which the hub 38 is arranged, is located on the rotor shaft. The hub 38 accommodates the rotor blades 4 and transmits the forces acting on the rotor blades 4 to the rotor shaft. The bearing arrangement 1 according to the invention is also applicable to other types of wind turbines.

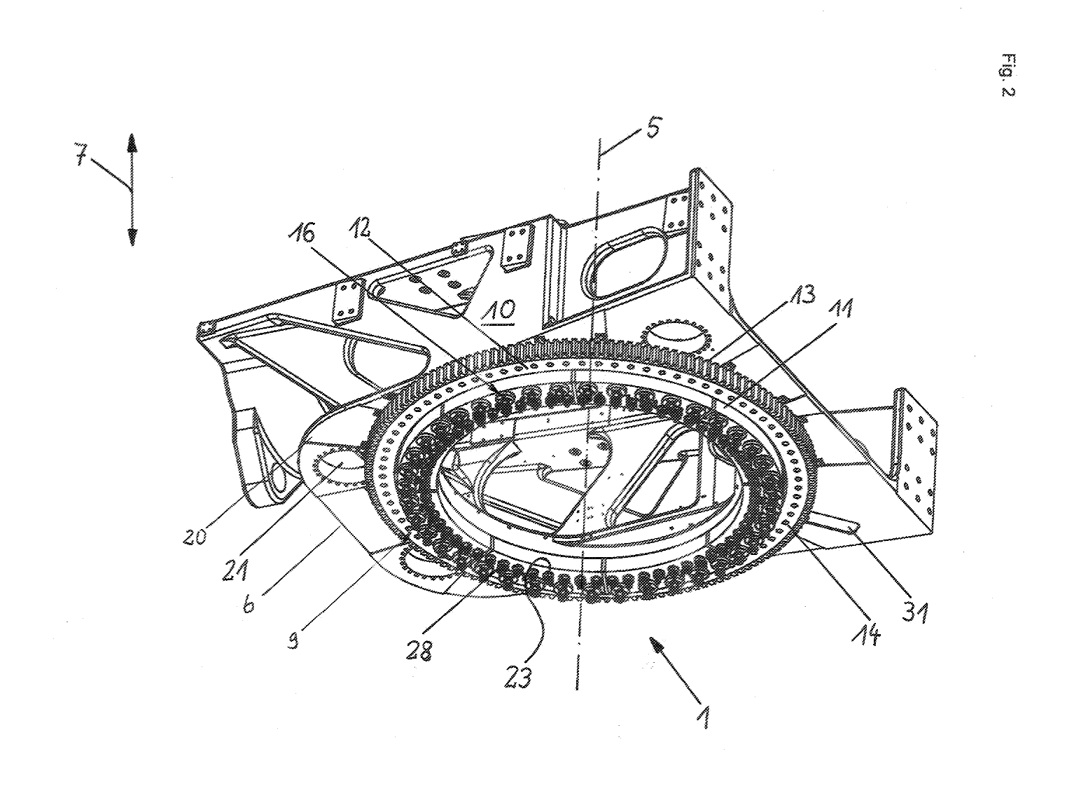

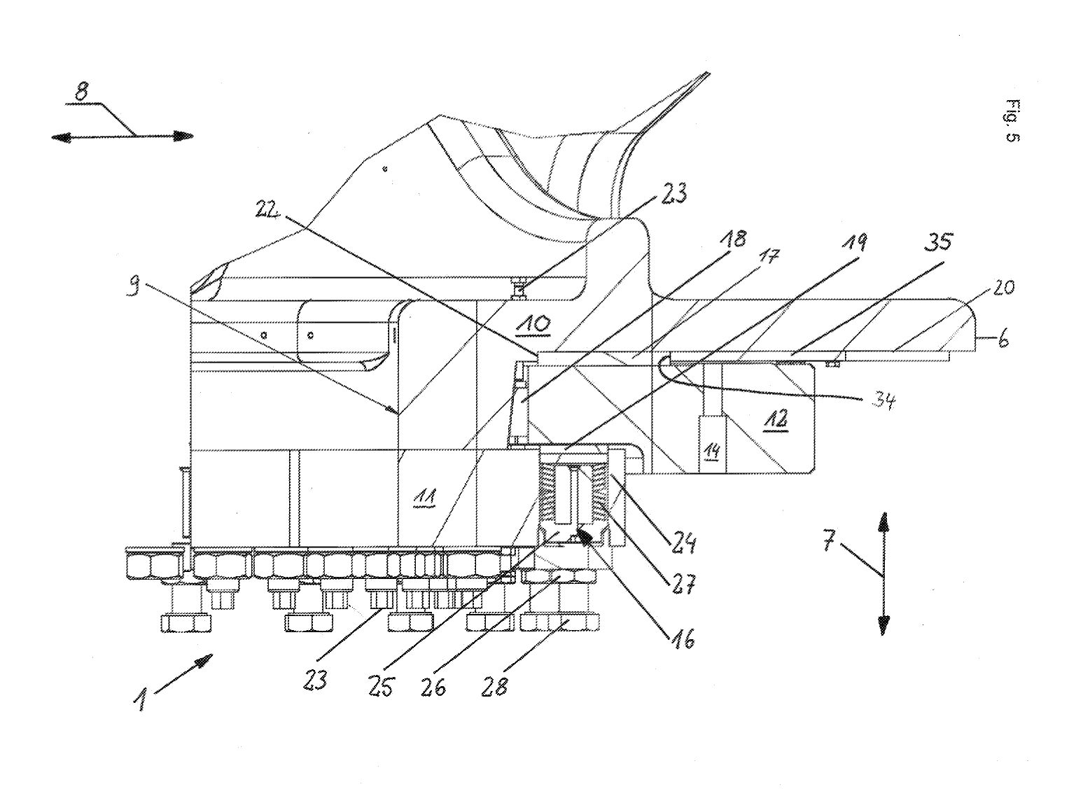

FIG. 2 shows the above-mentioned bearing arrangement 1 from the bottom side with reference to the assembly position. Here, the bearing arrangement 1 can be seen in an assembled state. A first bearing partner 9 is designed as a machine frame 10 with locking plates 11. The locking plates 11 are connected to the machine frame 10 in such a manner that they encompasses a second bearing partner formed as bearing ring 12 in the axial direction 8 from the inside (FIG. 5). The bearing ring 12 is provided with a gear ring 13 and can be connected via bores 14 with the tower flange of the tower 3. On the bearing ring 12 an external toothing system is provided, into which the non-illustrated azimuth drives can engage. To allow accommodating the azimuth drives in the machine frame 10, receiving recesses 21 for the drives are provided. In addition, in the locking plates 11 sliding devices 16 are provided, which are each equipped with an integrated, pre-tensioned gliding pad 19. Through adjusting screws 29 for the axial and radial pretension, bearing friction can be set in a wide range.

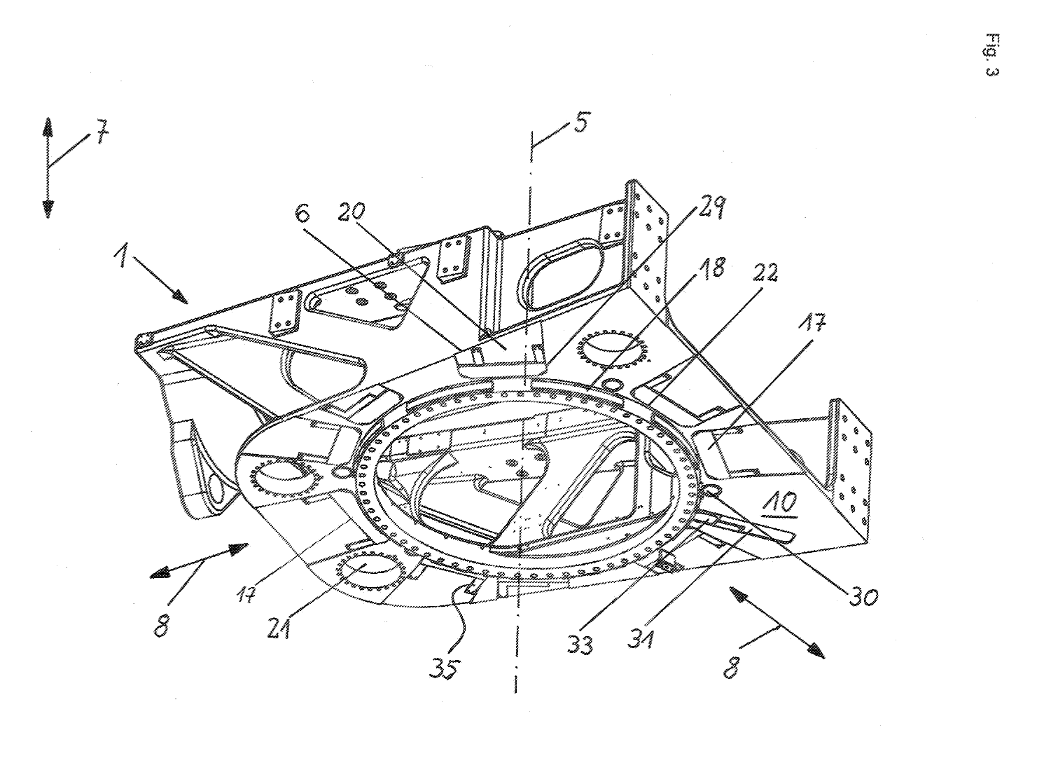

FIG. 3 discloses the bearing arrangement 1 according to FIG. 2, wherein the bearing ring 12 is not shown. Here, the machine frame 10 with axial and radial sliding bearing pads 17, 18 is shown. The axial gliding pads 17 are disposed in pockets 20, wherein the pockets 20 are provided in the material of the machine frame 10. The pockets 20 extend to the radial edge 6 of the machine frame 10. Thereby, the gliding pad 17 is particularly easily mountable in the radial direction 8. In the pockets 20 stoppers 22 can be arranged as locking arrester, which ensure that the axial gliding pad 17 cannot radially slide out of the pocket 20 during the operation. In addition, receiving bores 33 for hydraulic posts 30 are provided in the machine frame 10. These hydraulic posts 30 are used to improve the replacement of the gliding pad 17.

In a pocket 31 on the machine frame 10 a lubricating device 33 is provided for lubricating the axial bearing surface of the bearing ring 12 facing the machine frame 10 and the linings 17 of the machine frame 10. It is conceivable to arrange several lubricating devices distributed over the circumference. A simple felt pad with a lubricant supply ensures the lubrication of radial 18 and axial linings 17, 19.

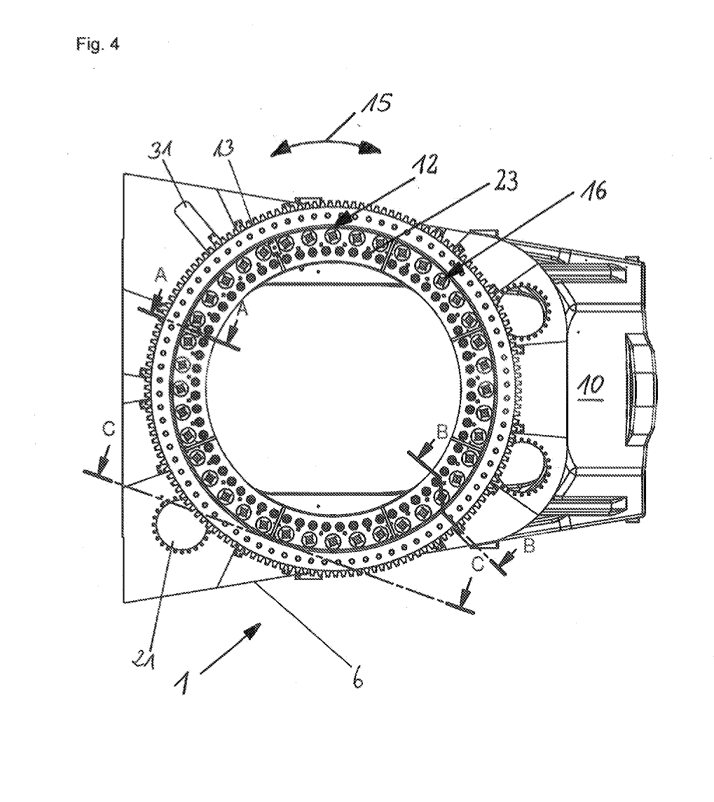

FIG. 4 shows a top view of the machine frame 10 with the assembled bearing 1. In FIG. 4, the sections A-A, B-B and C-C are marked, which are illustrated in FIGS. 5, 6 and 7, and are explained in the following.

Based on the section shown in FIG. 5 along the line B-B of FIG. 4, the detailed structure of the bearing arrangement 1 is described. Through the U-shaped contour of the first bearing partner 9, i.e. the machine frame 10 and the locking plate 11; it is achieved that the machine housing 37 cannot lift away from the second bearing partner, i.e. the bearing ring 12.

The lower sliding device 16, pre-tensionable in the locking plate 11, comprises a cylindrical housing 24, which is closed with a plug 25 in a form-fitting manner. An adjusting screw 28 with a lock nut 26, which acts on the disc springs 27, is axially screwed in this plug 25. The disc springs 27 generate a pretension force, which acts on the gliding pad 19. A bore, which is connectable to a non-illustrated lubricant supply, can lead through the sliding device 16.

To replace the gliding pads 17 of the machine frame 10, the pretension devices 16 are unscrewed so that the lower gliding pads 19 are released from the pretension. Thereafter, the hydraulic posts 30, which can be temporarily installed and can be operated by a hydraulic pump, are activated. In this way, the machine frame 10 is lifted away from the bearing ring 12 so that the gliding pads 17 are located on the bearing ring 12 in the pockets 20 or on the bearing ring 12 in an unloaded state. Then, the blocking means 22 is opened and the gliding pads 19 can be removed in the radial direction 8 out of the pockets 20 and replaced. After the replacement, the blocking means 22 is mounted again and the machine frame 10 is lowered.

To implement an active brake, instead of the disc spring units 27, actuatable operating means such as hydraulic cylinders 30 can be installed into the corresponding bores.

The radial gliding pads 18 rest against the machine frame 10 and are designed in a wedge form in this embodiment. The setting of the radial pretension is affected through the axial movement of the wedge-shaped gliding pad 18. For this purpose, adjusting screws 23 are provided in the machine frame 10, via which the radial pads 18 can be moved axially. Within the scope of the invention, alternatively, other radial bearings can also be provided, for example, this can also be designed in a bush form.

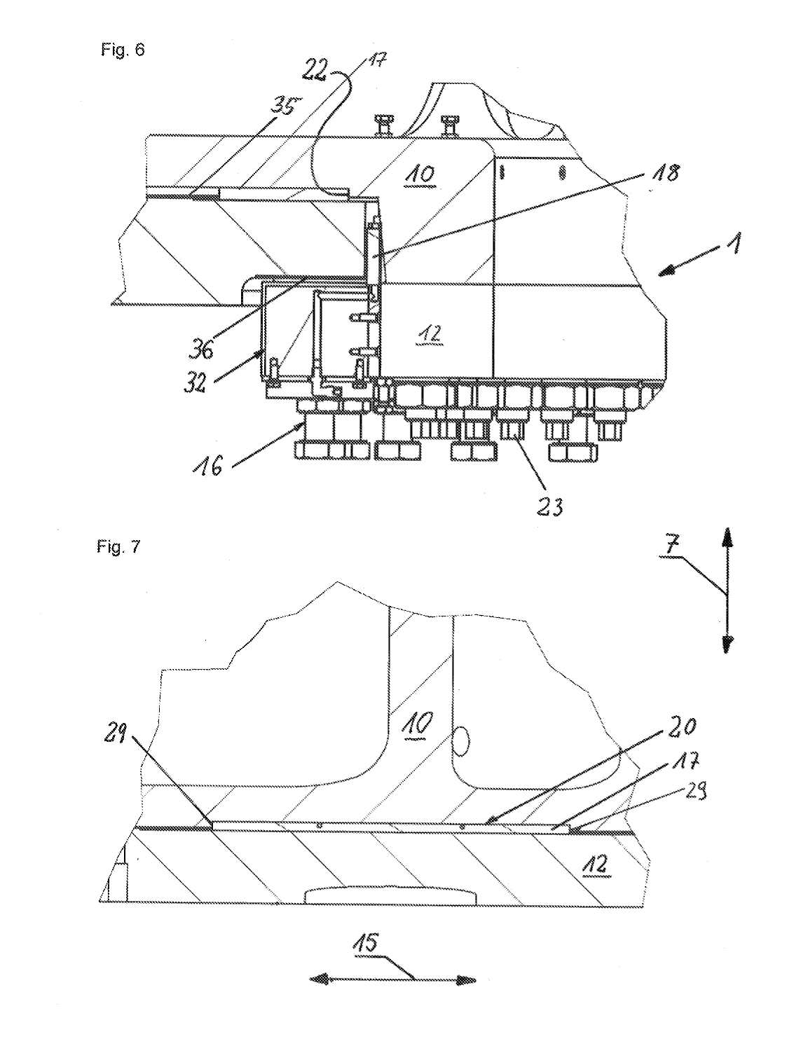

FIG. 6 shows a section along the line A-A. Here, the structure of the lower lubricating device 32 of the bearing arrangement 1 is illustrated. Here, the upper 17 and the radial gliding pads 18 between the machine frame 10 and the bearing ring 12 are shown. Fat, which lubricates the gliding pads 18, is fed via a bore to a felt lining 36.

FIG. 7 shows a section through the pocket 20 and the gliding pads 17 of the machine frame 10. This makes it clear that the upper gliding pad 17, non-rotatably connected to the machine frame 10, is provided in the pocket 20. The circumferential force acting on the gliding pad 17 and caused by the friction of the bearing arrangement 1 is transferred via arresters 29 in the circumferential direction 15 from the gliding pad 17 to the machine frame 10. These arresters 29 are formed by the tangential surfaces of the pocket 20.

The feature combinations disclosed in the described embodiments should not limit the invention, and instead, the features of different embodiments can also be combined with each other.

List of reference signs

| | |
|---|---|
| 1 | bearing arrangement |
| 2 | wind turbine |
| 3 | tower |
| 4 | rotor blade |
| 5 | rotation axis |
| 6 | edge |
| 7 | axial direction |
| 8 | radial direction |
| 9 | bearing partner |
| 10 | machine frame |
| 11 | locking plate |
| 12 | bearing ring |
| 13 | gear ring |
| 14 | bores for tower flange |
| 15 | circumferential direction |
| 16 | sliding device |
| 17 | gliding pad |
| 18 | gliding pad |
| 19 | gliding pad |
| 20 | pocket |
| 21 | receiving recess |
| 22 | arrester |
| 23 | adjusting screw |
| 24 | housing |
| 25 | plug |
| 26 | lock nut |
| 27 | disc spring |
| 28 | adjusting screw |
| 29 | tangential stop |
| 30 | hydraulic post |
| 31 | receiving pocket |
| 32 | lubricating device |
| 33 | lubricating device |
| 34 | arrester |
| 35 | stopper |
| 36 | felt lining |
| 37 | machine housing |
| 38 | hub |

1. A bearing device for a wind turbine, comprising
a first bearing partner and
a second bearing partner,
wherein both bearing partners are arranged rotatably relative to each other over a common axis,
with a gliding pad between the bearing partners acting in an axial direction, wherein
a pocket is provided in one of the bearing partners,
and the gliding pad is arranged in the pocket,
wherein at least one arrester is provided in the pocket in such a manner—that the gliding pad is mountable on the pocket, and
that a form-fit connection for power transmission acting in a circumferential direction is provided between the gliding pad and the bearing partners.

2. The bearing device according to claim 1, wherein the pocket is designed in such a manner that the gliding pad is mountable in a radial direction.

3. The bearing device according to claim 2, wherein the pocket extends to a radial edge of the bearing partner.

4. The bearing device according to claim 1, wherein the pocket comprises a first radially effective arrester, which limits the moving possibility of the gliding pad in the assembled state.

5. The bearing device according to claim 4, wherein a second radially effective arrester formed as a stopper is provided, which is mountable on the pocket in such a manner that it fixes the radial position of the assembled gliding pad.

6. The bearing device according to claim 1, wherein lifting means are provided, by means of which the bearing partners are lifted away from each other in such a manner that the gliding pad is arranged in the pocket in an unloaded state and is replaceable.

7. The bearing device according to claim 1, wherein one of the bearing partners is partially formed as a machine frame of a wind turbine, and the other bearing partner, the one particularly on an upper end of a tower of a wind turbine, is formed as a bearing ring.

8. The bearing device according to claim 1, wherein one bearing partner encompasses the other bearing partners in the axial direction, wherein a further axially effective gliding pad is provided between the bearing partners.

9. The bearing according to claim 1, wherein the pocket is provided as a recess directly in one of the bearing partners.

10. The bearing according to claim 1, wherein the pocket is provided as a recess directly in the machine frame.

11. The bearing device according to claim 1, wherein a lubricating device is provided in one bearing partner.

12. The bearing device according to claim 1, wherein at least one actively actuatable brake device is provided in one bearing partner.

13. Wind turbine with a machine housing pivoted on a tower and a rotor comprising a hub and at least one rotor blade, wherein a bearing device according to claim 1 is provided between the machine housing and the tower.
